(19) United States
(12) Patent Application Publication
(10) Pub. No.: US 2023/0159575 A1
(43) Pub. Date: May 25, 2023

(54) APPENDING AMINES TO METAL ORGANIC FRAMEWORKS

(71) Applicants: ExxonMobil Technology and Engineering Company, Annandale, NJ (US); GEORGIA TECH RESEARCH CORPORATION, Atlanta, GA (US)

(72) Inventors: Carter W. Abney, Athens, WI (US); Julie J. Seo, Clinton, NJ (US); Wenying Quan, Marietta, GA (US); William J. Koros, Atlanta, GA (US); Ryan P. Lively, Atlanta, GA (US); Aaron W. Peters, New Hope, PA (US); Anna C. Ivashko, Denville, NJ (US); Matthew T. Kapelewski, Flemington, NJ (US); Simon C. Weston, Annandale, NJ (US)

(21) Appl. No.: 18/058,071

(22) Filed: Nov. 22, 2022

Related U.S. Application Data
(60) Provisional application No. 63/282,796, filed on Nov. 24, 2021.

(51) Int. Cl. C07F 13/00; C07F 3/02

(52) U.S. Cl. CPC C07F 13/00; C07F 3/02

(57) ABSTRACT

Methods are provided for appending amines to metal organic framework (MOF) compositions. In some aspects, the methods can allow for appending of amines in the solution or synthesis solution used for synthesizing a MOF. In such aspects, an amine-appended MOF can be formed without having to first separate and dry the underlying non-amine-appended MOF composition. In other aspects, amines can be appended to an existing MOF composition by exposing the MOF to a suitable amine in a protic solvent, such as water or an alcohol.

### CROSS-REFERENCE TO RELATED APPLICATION

This application claims, under 35 U.S.C. § 119(e), the benefit of and priority to U.S. Provisional Patent Application No. 63/282,796, filed Nov. 24, 2021, the entire contents of which are fully incorporated by reference as if they were restated in full.

### FIELD

Methods are provided for appending amine-containing functional groups to metal organic framework materials.

### BACKGROUND

Metal organic frameworks (MOFs) are relatively new materials that can potentially be used in a variety of applications. One group of potential applications is related to use of MOFs as sorbent materials, such as materials for sorption of CO₂. The high surface area and pore structure of MOFs can potentially provide advantages in such sorption applications.

One option for enhancing the sorption capabilities of MOF materials is to append functional groups to an MOF material that provide enhanced and/or target sorption properties. For example, di-amine (or other poly-amine) functional groups can be appended to some types of MOF structures to provide amine-appended MOF materials with increased sorption capacity and/or a favorable type of isotherm, such as a Group V type sorption isotherm. Unfortunately, conventional methods for appending amines to MOF materials have generally involved reacting a MOF material with an amine-containing compound in an organic solvent at elevated temperatures. Such methods can be difficult to scale up for commercial production, due in part to safety concerns with handling of large quantities of such organic solvents. It would be desirable to have synthesis methods for forming amine-appended MOF materials that can avoid use of organic solvents that require specialized handling.

A journal article by Babaei et. al. (J. Chem Eng. Data (2018), Vol. 63, 1657-1662) describes amine functionalization of the MOFs MIL-100 and MIL-101 with p-phenylenediamine First, a synthesis mixture is used to form MIL-100 or MIL-101. The MIL-100 was recovered as a solid from a synthesis mixture, washed with acetone and deionized water, and then dried at ambient temperature in air. The MIL-101 was recovered by filtration from a synthesis mixture and then dried under vacuum. The resulting dried powder was then dissolved in dimethylformamide to remove unreacted linker, followed by filtration, washing with ethanol, and then drying at 343 K under vacuum. After forming the dried crystalline MOF, amines were appended by adding a sample of the MOF material to a solution of 10% p-phenylenediamine in ethanol, followed by refluxing at 373 K for 12 hours. The MOF compositions including the appended amines were then recovered by filtration, washing with ethanol, and drying at room temperature.

A journal article by Xian et. al. (Chem. Eng. Journal, Vol. 280 (2015) 363-369) describes impregnation of ZIF-8 with polyethylene imine After forming ZIF-8, the ZIF-8 powder was heated to 423 K under vacuum for 12 hours to remove water. A solution of polyethyleneimine in methanol was then added drop-wise to the dried ZIF-8 powder.

U.S. Pat. No. 10,780,388 describes the CO₂ sorption behavior of MOFs that have cyclic diamines such as (2-aminomethyl)piperidine appended to the MOF compositions.

### SUMMARY

In an aspect, a method of making an amine-appended metal organic framework composition is provided. The method includes dissolving a plurality of solid reagents in a solvent to provide a synthesis solution. The plurality of solid reagents can include at least one metal salt and at least one organic linker. The plurality of solid reagents can include at least one of a base or a buffer. It is noted that the at least one metal salt may serve as at least a portion of the base or buffer. The method further includes heating the synthesis solution to form an intermediate product mixture comprising a metal organic framework. The metal organic framework can include the metal of the at least one metal salt and the organic linker. Additionally, the method includes adding one or more polyamines to the intermediate product mixture to form an amine-appended metal organic framework. Optionally, the solvent in the intermediate product mixture can correspond to 50 vol % or more of water, an alcohol, or a combination thereof, after addition of the one or more polyamines.

In another aspect, a method of making an amine-appended metal organic framework composition is provided. The method includes washing a metal organic framework comprising a multi-ring disalicylate organic linker using a wash solvent to form a washed metal organic framework. The wash solvent can contain 90 vol % or more of one or more protic solvents. The washing can correspond to exposing the metal organic framework to the wash solvent two times or less. Additionally, the method includes exposing at least a portion of the washed metal organic framework to an appending solution by forming a suspension of the at least a portion of the washed metal organic framework in the appending solution. The appending solution can include one or more protic solvents and one or more polyamines. The appending solution can contain 50 vol % or more of water, an alcohol, or a combination thereof. Optionally, the wash solution can be different from the one or more protic solvents in the appending solution.

### BRIEF DESCRIPTION OF THE DRAWINGS

FIG. 1 shows PXRD data for EMM-44 formed by appending amines to EMM-67 in the intermediate product mixture used for forming the EMM-67.

FIG. 2 shows ¹H NMR data for the EMM-44 shown in FIG. 1 after recovery from the intermediate product mixture.

FIG. 3 shows ¹H NMR data for the EMM-44 shown in FIG. 1 after drying.

FIG. 4 shows ¹H NMR data for the EMM-44 shown in FIG. 1 after additional drying.

FIG. 5 shows a CO₂ adsorption isotherm for the EMM-44 shown in FIG. 4.

FIG. 6 shows ¹H NMR data for EMM-53 (3-4-3) formed by appending amines to EMM-67 in the intermediate product mixture.

FIG. 7 shows ¹H NMR data for EMM-53 (3-2-3) formed by appending amines to EMM-67 in the intermediate product mixture.

FIG. 8 shows PXRD data for EMM-44 formed by appending amines to previously synthesized EMM-67.

FIG. 9 shows ¹H NMR data for the EMM-44 shown in FIG. 8.

FIG. 10 shows a CO₂ adsorption isotherm for the EMM-44 shown in FIG. 9.

FIG. 11 shows PXRD data for EMM-53 formed by appending amines to previously synthesized EMM-67.

FIG. 12 shows ¹H NMR data for the EMM-53 shown in FIG. 11.

### DETAILED DESCRIPTION

In various aspects, methods are provided for appending amines to metal organic framework (MOF) compositions. In some aspects, the methods can allow for appending of amines in the solution or synthesis solution used for synthesizing a MOF. In such aspects, an amine-appended MOF can be formed without having to first separate and dry the underlying non-amine-appended MOF composition. In other aspects, amines can be appended to an existing MOF composition by exposing the MOF to a suitable amine in a protic solvent, such as water or an alcohol. This can avoid the use of conventional solvents for amine appending, such as toluene or hexane.

Metal organic frameworks are materials that can be formed by combining a metal ion precursor (or precursors) with a multi-dentate linker (or linkers) under appropriate conditions. A separate base or buffer can also optionally be present, or alternatively the metal ion precursor (such as a metal oxide) can provide sufficient basicity to allow for MOF formation. The metal ion precursor and linker can be mixed and optionally heated to facilitate the reaction for forming the MOF. Conventionally, after formation of a MOF material, the MOF is separated from the synthesis mixture (such as the synthesis solution) and then dried to recover the crystalline MOF material.

Some examples of MOF materials are MOFs that are formed using multi-ring disalicylate linkers. MOF-274 corresponds to a general family of such materials. One example of MOF-274 is EMM-67, which is a MOF material based on the linker H₄dobpdc (4,4′-dihydroxy-1,1′-biphenyl-3,3′-dicarboxylic acid). Various metals or combinations of metals can be used to form EMM-67, such as a mixture of Mn and Mg.

Although MOF-274 can act as a sorbent for various compounds, such as CO₂, a composition with increased sorption capacity and/or a modified sorption isotherm can be formed by appending amines to a MOF-274 material. The appended amines can correspond to a di-amine, a tetra-amine, or another type of poly-amine Conventionally, such amines are appended to MOF materials by first synthesizing a MOF material, separating and then drying the MOF material to recover an at least partially crystalline MOF (possibly containing various impurities). The dried, crystalline MOF is then exposed to a polyamine in the presence of a solvent, such as toluene or hexane.

Conventionally, amine appending is performed on MOF materials after separating the MOF materials from the synthesis solution used for formation of the MOF. It is conventionally believed that the traditional solvents used for MOF formation interfere with the amine-appending process. For example, for MOFs based on multi-ring disalicylate linkers, traditional synthesis mixtures for forming MOFs typically include a majority of organic solvents, while including only 30 vol % or less of protic solvents such as water. Additionally, for solvents used in conventional synthesis mixture, it is conventionally believed that separating the MOF materials from the synthesis solution can help to ensure that the MOFs are fully formed prior to contacting the MOFs with the amines for appending.

In various aspects, it has been discovered that MOFs with appended amines can be created in the synthesis solution used for synthesis of a MOF without having to first separate and dry the underlying non-appended-amine MOF structure. In particular, when the synthesis solution for forming a MOF corresponds to a synthesis solution based on a protic solvent, it has been discovered that amine precursors for appending can be added to the intermediate product mixture (after MOF formation but before recovery of the MOF from the solution) to allow for formation of amine-appended MOF compositions. In such aspects, after mixing and any optional heating of a synthesis solution for forming a MOF, the solution can be cooled to a target temperature, such as roughly ambient temperature (such as a temperature between 10° C. and 80° C.) Amines for appending to the MOF can then be added to the solution at this stage. It is noted that a higher target temperature can be selected if it is more convenient for the addition of the amines After addition of amines, the solution (including the amines) can be mixed, followed by allowing the solution to rest (optionally with additional heat). The MOF including the appended amines can then be recovered as a crystalline structure (optionally containing impurities) from the solution. It has been discovered that a MOF including appended amines can be recovered as a crystalline structure in spite of the additional presence of the appended amines during crystallization/recovery.

It is noted that the ability to form amine-appended MOFs directly from an initial synthesis solution based on protic solvents can provide a variety of advantages. First, a number of manufacturing steps can be avoided, as a MOF composition does not need to be dried and crystallized, followed by subsequent addition to a protic solvent containing an amine for appending. Additionally, amines can be appended in a solution based on a protic solvent while reducing, minimizing, or eliminating the need to add non-polar organic solvents such as hexane or toluene. In addition to simplifying the synthesis conditions, avoiding the use of organic solvents can also simplify handling of the remaining portions of the solution after recovery of the amine-appended MOF compositions. Another advantage of amination directly into the synthesis solution is that not only are the intermediate MOF separation and drying steps avoided but so are the multiple time consuming solvent wash/soak steps that are typically done in-between the separation and drying steps.

In various additional aspects, MOFs with appended amines can be formed in a protic solvent environment by addition of amines to MOFs that have previously been separated from the initial synthesis solution. Although protic solvents, such as alcohols, are known to strip amines from MOF compositions that include appended amines, it has been discovered that amines can be appended to MOF compositions in such protic solvents. Additionally, it has further been discovered that amine appending in a protic solvent can be used to allow for amine addition while reducing or minimizing the amount of solvent washing of the MOF that is required prior to amine appending.

### Amine Appending in Intermediate Product Mixture

In various aspects, it has been discovered that amines can be appended to MOF compositions in the solution used for forming the MOF composition without having to first separate and dry the MOF compositions. This can be achieved for MOFs formed in synthesis solutions where 50 vol % or more of the solvent corresponds to water, alcohol, or a combination thereof, or 70 vol % or more, or 90 vol % or more, such as up to having substantially all of the solvent in the synthesis solution correspond to water, alcohol, or a combination thereof.

To perform amine appending, a synthesis solution can be formed where 50 vol % or more (such as up to substantially all) of the solvent corresponds to water, alcohol, or a combination thereof. The synthesis solution can also include effective amounts of a metal precursor (or precursors), a linker, and optionally a base and/or buffer. The synthesis solution can then be mixed and/or heated as needed for a sufficient period of time to allow for formation of an MOF based on the metal(s) and the linker. After formation of MOF material in the solution, the solution can be referred to as an intermediate product mixture. It is noted that the MOF material in the intermediate product mixture may be present in the form of a precipitated and/or suspended solid, such as a crystalline solid.

At this point in the synthesis, instead, of separating the resulting MOF from the intermediate product mixture, one or more amines for appending to the MOF can be added to the solution. The intermediate product mixture including the amines can then be mixed, followed by maintaining the intermediate product mixture (including amines) at a target temperature for an additional period of time. The MOF compositions including appended amines can then be recovered from the solution.

Amines can be appended to MOF materials by addition of amines to the intermediate product mixture for a wide range of solution concentrations. Depending on the aspect, the initial synthesis solution for forming the MOF material can have a solids content ranging from 0.01 wt % to 40 wt %, or 0.01 wt % to 20 wt %, or 0.1 wt % to 40 wt %, or 0.1 wt % to 35 wt %, or 0.1 wt % to 30 wt %, or 0.1 wt % to 25 wt %, or 0.1 wt % to 20 wt %, or 1.0 wt % to 40 wt %, or 1.0 wt % to 35 wt %, or 1.0 wt % to 30 wt %, or 1.0 wt % to 25 wt %, or 1.0 wt % to 20 wt %, or 10 wt % to 40 wt %, or 10 wt % to 30 wt %. Additionally or alternately, after formation of MOF material, the resulting intermediate product mixture can have a solids content ranging from 0.01 wt % to 40 wt %, or 0.01 wt % to 20 wt %, or 0.1 wt % to 40 wt %, or 0.1 wt % to 35 wt %, or 0.1 wt % to 30 wt %, or 0.1 wt % to 25 wt %, or 0.1 wt % to 20 wt %, or 1.0 wt % to 40 wt %, or 1.0 wt % to 35 wt %, or 1.0 wt % to 30 wt %, or 1.0 wt % to 25 wt %, or 1.0 wt % to 20 wt %, or 10 wt % to 40 wt %, or 10 wt % to 30 wt %. In this discussion, the solvent in a synthesis solution or intermediate product mixture is defined as the portion of a synthesis solution/intermediate product mixture that is a liquid at 20° C. and 100 kPa-a.

It is noted that some organic compounds correspond to weak bases that can potentially serve as both part of the solvent environment and as weak bases for control of pH in the solvent environment. To the degree that such organic compounds are liquids at 20° C. and 100 kPa-a, such organic compounds are considered as part of the solvent. It is further noted that solid reagents involved in the synthesis reaction for the metal organic framework composition are not considered as part of the solvent when determining the vol % of water in the solvent environment. For example, if an aqueous solution of sodium hydroxide is used as a base in the synthesis solution, the sodium hydroxide itself is not considered as part of the solvent. Only the water from the sodium hydroxide solution is counted as part of the solvent. Finally, to the degree that an amine for appending corresponds to a liquid at 20° C. and 100 kPa-a, such amine reagents are not counted as part of the solvent when added to the intermediate product mixture. However, one or more polyamines may be solid at room temperature.

In the synthesis solution and/or the intermediate product mixture prior to addition of amines, the solvent can correspond to 50 vol % or more of water, an alcohol, or a combination thereof, or 60 vol % or more, or 70 vol % or more, or 80 vol % or more, or 90 vol % or more, such as up to substantially all of the solvent (i.e., ˜100 vol %) corresponding to water, an alcohol, or a combination thereof. In some aspects, the solvent in the synthesis solution/intermediate product mixture prior to addition of amines can correspond to 50 vol % or more of water, or 60 vol % or more, or 70 vol % or more, or 80 vol % or more, or 90 vol % or more, such as up to substantially all of the solvent (i.e., ˜100 vol %) corresponding to water. In other aspects, the solvent in the synthesis solution/intermediate product mixture prior to addition of amines can correspond to 50 vol % or more of an alcohol, or 60 vol % or more, or 70 vol % or more, or 80 vol % or more, or 90 vol % or more, such as up to substantially all of the solvent (i.e., ˜100 vol %) corresponding to an alcohol. Examples of alcohols include, but are not limited to, methanol, ethanol, isopropyl alcohol, and/or other alcohols that include 4 carbons or less (C₄₋ alcohols).

After forming MOF materials from a solution where 50 vol % or more of the solvent is water, an alcohol, or a combination thereof, the temperature of the intermediate product mixture can be adjusted to a target temperature for performing the amine appending. The amine appending can be performed at any convenient temperature. Ambient temperature (−20° C.) can be suitable in some aspects. For an amine reagent that is solid at 20° C. and 100 kPa-a, it may be beneficial to adjust the temperature of both the intermediate product mixture and the amine reagent to a temperature higher than 20° C. so that the amine can be added and mixed as a liquid reagent.

The amine reagent(s) can then be added to the intermediate product mixture to allow for appending of amines. In some aspects, because solvent is already present in the intermediate product mixture after MOF formation, the amine reagent(s) can be added without addition of additional solvent. In other aspects, additional solvent can be added along with the amine reagent(s). When additional solvent is added with the amine reagent(s), after addition of the amines, 50 vol % or more of the combined solvent from the intermediate product mixture and the additional solvent added with the amine reagent(s) can correspond to water, an alcohol, or a combination thereof, or 60 vol % or more, or 70 vol % or more, or 80 vol % or more, or 90 vol % or more, such as up to substantially all of the combined solvent (i.e., —100 vol %). Additionally or alternately, when additional solvent is added with the amine reagent(s), 50 vol % or more of the additional solvent can correspond to water, an alcohol, or a combination thereof, or 60 vol % or more, or 70 vol % or more, or 80 vol % or more, or 90 vol % or more, such as up to substantially all of the additional solvent (i.e., —100 vol %).

In some aspects, the addition of amines to the intermediate product mixture can result an amine concentration in the solution of 5 vol % to 35 vol %, or 10 vol % to 30 vol %, or 15 vol % to 30 vol %. It is noted that any additional solvent that is introduced with the amines is included when determining the vol % of amines after addition to the intermediate product mixture.

After adding amines (and optional solvent) to the intermediate product mixture, the intermediate product mixture can be mixed so that the amine reagent(s) are distributed throughout the intermediate product mixture. The intermediate product mixture can then be maintained for a period of time to allow for formation of MOF materials with appended amines. This time period for formation of MOF materials with appended amines can correspond to 0.1 hours to 72 hours. It is noted that mixing can optionally be performed during the time for formation of the amine-appended MOF materials.

After forming the amine-appended materials, the amine-appended materials can be recovered from the solution by any convenient method. Suitable recovery methods can include, but are not limited to, centrifugation, filtration, vacuum drying, or another convenient method.

A variety of types of amines can be used for forming a MOF material with appended amines Generally, the amines can correspond to diamines, tetramines, or other amines that include two or more amine functionalities per molecule. Any convenient amine that is known for use in forming MOF materials with appended amines can be used with the methods described herein. Examples of amines that can be appended include, but are not limited to, 2-aminomethylpiperidine, p-phenylenediamine, and N¹,N^{1′}-(butane-1,4-diyl)bis(propane-1,3-diamine). It is noted that N¹,N^{1′}-(butane-1,4-diyl)bis(propane-1,3-diamine) is an example of a tetraamine

### Amine Appending to MOF Materials in Protic Solutions

In various additional aspects, protic solutions can also be used for appending amines to MOF materials that have previously been separated from the solution used to form the MOFs. Because the MOF materials have been separated from the initial synthesis solution, the MOFs can be added to/suspended in a solvent that contains a sufficient concentration of the amines for appending.

The solution containing the amines can correspond to a solution of amines in a protic solvent. The concentration of amines can correspond to 5.0 vol % to 35 vol % of the solution, or 10 vol % to 30 vol %, or 15 vol % to 30 vol %. The protic solution can contain 50 vol % or more of water, alcohol, or a combination thereof, or 60 vol % or more, or 70 vol % or more, or 80 vol % or more, or 90 vol % or more, such as up to 100 vol %. After addition of the MOF materials, the MOF materials can correspond to 40 wt % or less of the weight of the MOF materials plus amine solution.

A variety of types of amines can be used for forming a MOF material with appended amines Generally, the amines can correspond to diamines, tetramines, or other amines that include two or more amine functionalities per molecule. Any convenient amine that is known for use in forming MOF materials with appended amines can be used with the methods described herein. Examples of amines that can be appended include, but are not limited to, 2-aminomethylpiperidine, p-phenylenediamine, and N¹/N^{1′}-(butane-1,4-diyl)bis(propane-1,3-diamine).

After addition of the MOF materials to the amine solution, the solution can be mixed followed by maintaining the solution for a period of time to allow for formation of MOF materials with appended amines. This time period for formation of MOF materials with appended amines can correspond to 0.1 hours to 72 hours. After forming the amine-appended materials, the amine-appended materials can be recovered from the solution by any convenient method. Suitable recovery methods can include, but are not limited to, centrifugation, filtration, vacuum drying, or another convenient method.

Prior to addition of MOF materials to an amine solution, the MOF materials can optionally be washed in a protic solvent, such as washing with an alcohol. Optionally, the MOF materials can be dried after such washing.

In some aspects, it has been discovered that using a protic solution for amine appending can provide the advantage of reducing or minimizing the number of wash steps and/or the amount of wash solvent that are needed for preparing an amine-appended MOF. In particular, by using a protic solution for amine appending, the amine appending step can be used as a wash step for removing synthesis solution materials that are entrained or trapped in the MOF material.

In conventional MOF synthesis methods, after synthesizing an MOF material from a synthesis solution, the resulting MOF material is separated and dried to remove any excess solvent. The MOF is then typically washed a plurality of times after separating the MOF material from the initial organic-based synthesis solution environment. The plurality of wash steps typically includes at least one wash step involving an organic solvent. The goal of these conventional wash steps is to remove unreacted material and/or impurities from the MOF material prior to use. Conventionally, when amine appending is performed, the plurality of wash steps are used to remove unreacted material/impurities are performed prior to attempting to append amines to the MOF. The amine appending is then performed.

In various aspects, instead of using a plurality of wash steps, including at least one wash step corresponding to a non-protic organic solvent, it has been discovered that amine-appending can be performed as part of a final wash step for an MOF material. In such aspects, after synthesizing and drying an MOF material, the MOF material can be washed one time or two times using a substantially protic solvent. For example, the MOF material can be washed in a solvent where 90 vol % or more of the solvent corresponds to one or more protic solvents, such as water, ethanol, and/or isopropyl alcohol. The final wash for the MOF material can then correspond to both a wash step and an amine-appending step, with the wash solution corresponding to a protic solution that also includes the amines for appending. In addition to reducing or minimizing the number of separate wash steps needed for subsequent amine appending, using an amine-appending solution as the final wash solution can also avoid the need for drying of the MOF material prior to performing amine appending.

### Definitions

All numerical values within the detailed description and the claims herein are modified by “about” or “approximately” the indicated value, and take into account experimental error and variations that would be expected by a person having ordinary skill in the art.

It is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions apply:

As used herein, the terms “a” and “the” as used herein are understood to encompass the plural as well as the singular.

As used herein, the term “heteroatom” includes oxygen (O), nitrogen (N), sulfur (S) and silicon (Si), boron (B) and phosphorous (P).

The term “multi-ring” is defined herein to refer to compounds that include two or more ring structures. The rings can correspond to fused rings, such as a naphthalene-type structure, rings bonded together without sharing an atom, such as a biphenyl linkage, or rings separated by one or more atoms, such as rings separated by a methyl linkage. This is in contrast to a single-ring compound. A multi-ring compound can include multiple aromatic rings, multiple non-aromatic rings (such as saturated rings and/or rings including an insufficient number of double bonds to provide aromaticity), or a combination thereof.

The term “aryl” means, unless otherwise stated, a polyunsaturated, aromatic substituent that can be a single ring or multiple rings fused together or linked covalently. In an aspect, the substituent has from 1 to 11 rings, or more specifically, 1 to 3 rings. The term “heteroaryl” refers to aryl substituent groups (or rings) that contain from one to four heteroatoms selected from N, O and S, wherein the nitrogen and sulfur atoms are optionally oxidized, and the nitrogen atom(s) are optionally quaternized. An exemplary heteroaryl group is a six-membered azine, e.g., pyridinyl, diazinyl and triazinyl. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

As used herein, the terms “alkyl,” “aryl,” and “heteroaryl” can optionally include both substituted and unsubstituted forms of the indicated species. Substituents for the aryl and heteroaryl groups are generically referred to as “aryl group substituents.” The substituents are selected from, for example: groups attached to the heteroaryl or heteroarene nucleus through carbon or a heteroatom (e.g., P, N, O, S, Si, or B) including, without limitation, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR, -halogen, —SiR′R″R′″, —OC(O)R′, —C(O)R′, —CO.sub.2R′, —CONR′R″, —OC(O)NR′R″, —NR″C(O)R′, —NR—C(O)NR″R′″, —NR″C(O).sub.2R′, —NR—C(NR′R″R′″).dbd.NR′″, —NR—C(NR′R″)═NR′″, —S(O)R′, —S(O)R′, —S(O)NR′R″, —NRSOR′, —CN and, —R, —CH(Ph), fluoro(C₁-C₄)alkoxy, and fluoro(C₁-C₄)alkyl, in a number ranging from zero to the total number of open valences on the aromatic ring system. Each of the above-named groups is attached to the aryl or heteroaryl nucleus directly or through a heteroatom (e.g., P, N, O, S, Si, or B); and where R, R′, R′″ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R, R″, R′″ and R″″ groups when more than one of these groups is present.

The term “alkyl,” by itself or as part of another substituent, means, unless otherwise stated, a straight or branched chain, or cyclic hydrocarbon radical, or combination thereof, which may be fully saturated, mono- or polyunsaturated and can include di-, tri- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.”

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH.₂—NH—CH₃, —CH₂—CH₂—N(CH₃)—CH₃, —CH₂—S—CH₂—CH₃, —CH₂—CH₂, —S(O)—CH₃, —CH₂, —CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —CO₂R′— represents both —C(O)OR′ and —OC(O)R′.

As used herein, the term “linker” refers to one or more organic molecules that bonds to one or more metals to form an MOF.

As used herein, the term “ligand” means a molecule containing one or more substituent groups capable of functioning as a Lewis base (electron donor). In an aspect, the ligand can be oxygen, phosphorus or sulfur. In an aspect, the ligand can be an amine or amines containing 1 to 10 amine groups. The ligand can bind to an MOF after it is formed.

The term “polyamine” refers to a compound that includes a plurality of amine groups. Examples of polyamines are diamines and tetraamines

The terms “halo” or “halogen,” by themselves or as part of another substituent, mean, unless otherwise stated, a fluorine, chlorine, bromine, or iodine atom.

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

As used herein, the term “Periodic Table” means the Periodic Table of the Elements of the International Union of Pure and Applied Chemistry (IUPAC), dated December 2015.

The term “salt(s)” includes salts of the compounds prepared by the neutralization of acids or bases, depending on the particular ligands or substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

In some optional aspects, deoxygenated water can be used. Deoxygenated water corresponds to water with an oxygen content of 0.1 wppm or less, or 0.01 wppm or less. The water can be deoxygenated by any convenient method, such as sparging the water by passing nitrogen gas through the water in substantially oxygen-free atmosphere (such as under a nitrogen blanket). More generally, sparging and/or other deoxygenation techniques can be used to deoxygenate mixtures of water and an organic solvent.

Synthesis of Metal Organic Framework Materials: High Water and/or High Solids Synthesis Methods

In aspects where amine appending is performed in an intermediate product mixture (i.e., the synthesis solution for forming a MOF material), the MOF material can be formed using a synthesis solution that contains 40 vol % or more of water (such as up to 100 vol %). Forming a MOF material from such a synthesis solution can result in an intermediate product mixture with a sufficient content of protic solvent to allow for amine appending prior to separating the MOF material from the intermediate product mixture. MOF materials that are based on multi-ring disalicylate linkers are examples of MOF materials that can be formed using a synthesis solution that contains 40 vol % or more of water.

In some aspects, the solvent environment for performing synthesis of the metal organic framework composition can correspond to water, such as deoxygenated water. In such aspects, bases such as sodium hydroxide can be added to the aqueous environment to control the pH of the aqueous environment. Additionally or alternately, metal reagents can be used that correspond to metal oxides, metal hydroxides, metal carbonates, and/or metal acetates in order to control the pH of the aqueous environment.

In other aspects, the solvent environment can correspond to a mixture of water and organic solvent. Alcohols are examples of organic solvents that can be used, such as C₄₋ alcohols that have reduced or minimized requirements for safety handling relative to conventional organic solvents. Examples of suitable alcohols include ethanol and isopropyl alcohol, although methanol and the isomers of propanol and n-butanol can also be suitable. Other examples of organic solvents can include other oxygenated solvents such as tetrahydrofuran. In aspects where the solvent corresponds to a mixture of water and one or more other organic solvents, water can correspond to 40 vol % to 99 vol % (or 50 vol % to 99 vol %) of the solvent. In this discussion, a solvent including 99.0 vol % or more of water is defined as a solvent that consists essentially of water. In such aspects, one or more buffers can be added to the solvent environment to control the pH of the solvent environment. Additionally or alternately, metal reagents can be used that correspond to metal oxides, metal hydroxides, metal carbonates, and/or metal acetates in order to control the pH of the solvent environment.

By way of nonlimiting example, metal organic frameworks can be synthesized by dissolving one or more metal salts with one or more linkers in a solvent at a target molar ratio to produce a synthesis solution. This target molar ratio can be specified, for example, based on the moles of linkers to combined moles of metals in the metal salts. In various aspects, the ratio of linkers to metals in the metal salts in the synthesis solution can be 0.20 to 0.60, or 0.25 to 0.60, or 0.30 to 0.60, or 0.20 to 0.55, or 0.25 to 0.55, or 0.30 to 0.55., or 0.20 to 0.50, or 0.25 to 0.50. It is noted that the metals in the metal salts refers to metals from the metal salts for incorporation into the metal organic framework composition. Metals added as part of a base or buffer (such as Na from NaOH) are not included, as metals such as Na are not incorporated in a stoichiometric manner into the metal organic framework composition. However, metals such as MgO, Mg(OH)₂, or Mn(OH)₂ are included, as such metals correspond to reagents containing metals that are stoichiometrically incorporated into the metal organic framework composition. It is noted that in this discussion, metal oxides are included within the definition of a metal salt.

It is noted that when solid reagents are dissolved, the dissolved reagents may only correspond to a portion of the total amount of reagent that is added to the solvent. In some aspects, an additional portion of one or more solid reagents may be present as a dispersed solid in a synthesis solution.

It was unexpected that synthesis of MOF-274 metal organic framework compositions and/or metal organic framework compositions including multi-ring disalicylate organic linkers could be achieved in an aqueous solvent environment and/or an environment where water corresponds to 40 vol % or more of the solvent environment. Conventionally, synthesis of MOF-274 is performed in organic solvents, such as mixtures of methanol and N,N-dimethylformamide Based on Hansen solubility parameters, some variation in solvent systems can be used, and water can potentially be included as a portion of a solvent when attempting to build similar solvent systems. However, one of the three types of Hansen solubility parameters is δ_{H}, which is related to the hydrogen bonding characteristics of a potential solvent. The δ_{H} value for water is extremely high relative to even alcohols such as methanol. Thus, when attempting to identify potential alternative solvent systems based on Hansen solubility parameters, it would be expected that water would need to be paired with organic solvents with low δ_{H} values. This would exclude combinations of water with any substantial amount of alcohols. Additionally, the amount of water would need to be limited to roughly 30 vol % or less even when paired with organic solvents having low δ_{H} values, so that the combined solvent system would have a comparable δ_{H} to a conventional organic solvent system. It is further noted that because of the multi-ring nature of the linker, it would not be expected that a synthesis procedure for a metal organic framework based on a single-ring linker would be relevant to identifying synthesis conditions for MOF-274. For example, single-ring linkers would be expected to have higher solubility in aqueous environments than multi-ring linkers. Additionally, multi-ring linkers are generally used for formation of larger pore materials than single ring linkers. Such larger pore sizes increase the difficulty with production of the materials, because larger pore sizes can accommodate other defect phases and/or can be susceptible to pore collapse.

In contrast to the conventional understanding based on Hansen solubility parameters, it has been unexpectedly discovered that water or water/alcohol solvents can be used as the solvent environment for synthesis of MOF-274 metal organic framework structures. Additionally, it has further been discovered that this unexpected solvent environment can be used to synthesize MOF-274 metal organic framework structures using reagent concentrations that are substantially higher than the reagent concentrations for a conventional synthesis procedure in conventional organic solvents.

The metal organic framework compositions formed using water or high water content solvents as the solvent environment can have various characteristics. In some aspects, the metal organic framework compositions can have a surface area, as determined by nitrogen adsorption (ASTM D3663, BET surface area) of 700 m²/g or more, or 900 m²/g or more, or 1500 m²/g or more, such as up to 4000 m²/g or possibly still higher. Additionally or alternately, the metal organic framework compositions can have a pore volume, as determined by nitrogen adsorption (ASTM D4641) of 0.6 cm³/g to 1.6 cm³/g.

By using a solvent environment that is at least partially based on water, it has been discovered that the reagent concentration in the synthesis solution can be increased to include up to 30 times as much of the reagents as a conventional solvothermal synthesis in organic solvents. As used herein, the term “solid reagents” refers to a combination of one or more metal salts and one or more organic linkers (“linkers”). Generally, the organic linker can correspond to a multi-ring linker. In some aspects, the organic linker includes multiple bridged aryl species such as molecules having two or more phenyl rings or two phenyl rings joined by a biphenyl, vinyl, or alkynyl group. For example, an organic linker can correspond to a disalicylate. In some aspects, a plurality of rings in the multi-ring disalicylate organic linker can include a salicylate functional group.

The increase in reagent concentration in the solution is facilitated in part by the higher solubility of the various types of solid reagents in an at least partially aqueous environment. In aspects where the solvent environment also includes an alcohol, a buffer can be added to the solvent to maintain the pH in a desired range in order to further facilitate dissolution of the high concentrations of solid reagents. In aspects where water is substantially the only solvent (i.e., 99 vol % or more of the solvent is water), a base can be added to adjust the pH of the water.

The synthesis can include methods of making metal organic frameworks where one or more metal salt(s), one or more linkers, and optionally a buffer mixture and/or a base are combined and dissolved in an at least partially aqueous solvent to provide a synthesis solution. It is noted that if one or more metal salts corresponds to a metal oxide, metal hydroxide, metal carbonate, and/or a metal acetate, a buffer or base may not be needed. Similarly, if a portion of the solvent corresponds to a base, a separate buffer or base may not be needed. Optionally, dissolution of the reagents can include stirring of the solution until full dissolution is achieved. The synthesis solution is then sealed and heated by one of various methods.

In an aspect, the cumulative concentration of one or more metal salts can be provided in an amount between 100 mM and 4850 mM (or equivalently 0.1 M to 4.85 M). In an aspect, one or more linkers can be provided in an amount between 30 mM and 1950 mM (or equivalently 0.03 M to 1.95 M). In aspects where a buffer is added, the buffer concentration can be between 100 mM and 7800 mM (or equivalently 0.1 M to 7.8 M). In aspects where a base is added, the base concentration can be between 100 mM and 5000 mM (or equivalently 0.1 M to 5.0 M). In such aspects, the synthesis solution can have a combined concentration of metal salts and linkers of 130 mM to 6800 mM (or equivalently 0.13 M to 6.8 M). In such aspects, the synthesis solution can have a total reagent concentration (metal salts, linkers, optional buffer and/or base) of 230 mM to 14500 mM (or equivalently 0.23 M to 14.5 M).

Additionally or alternately, in some aspects, still higher concentrations of metals plus linkers can be used. In some aspects, a high solids synthesis solution can have a combined concentration of metals plus linkers of 2.1 moles or more per liter of solvent (i.e., a molarity of 2.1 M or more), 2.5 M or more, or 3.0 M or more, or 3.5 M or more, such as up to 15 M or possibly still higher. For example, if a synthesis solution includes water as a solvent and further includes 2.0 moles per liter (2.0 M) of Mg and 1.5 moles per liter (1.5 M) of linker, the combined concentration would be 3.5 M. Additionally or alternately, the concentration of metals in the synthesis solution can be 1.5 M or more (i.e., 1.5 moles of metal or more per liter of solvent), or 2.0 M or more, or 2.5 M or more, such as up to 15 M or possibly still higher. Further additionally or alternately, the concentration of linkers in the synthesis solution can be 0.6 M or more, or 1.0 M or more, or 1.5 M or more, such as up to 10 M or possibly still higher. It is noted that for molarity values above 15 M, the amount of solids is high enough that it is generally more appropriate to specify a weight, volume, and/or mole percentage of solids in the synthesis mixture, as opposed to expressing a molar quantity of solids per liter of solvent.

In various aspects, the metal salts can be divalent metal salts. For example, the metal salts can be a divalent first-row transition metal salt having the formula MX₂ such as M=Mg, Mn; X₂=(Oac)₂, (HCO₃)₂, (F₃CCO₂)₂, (acac)₂, (F₆acac)₂, (NO₃)₂, SO₄; M=Ni, X₂=(Oac)₂, (NO₃)₂, SO₄; M=Zn, X₂=(Oac)₂, (NO₃)₂. In an aspect, the metal salts can be in the form of crystals or crystalline powder. In an aspect, the metal salts are Mg(NO₃)₂.6H₂O and MnCl₂.4H₂O for example. In some aspects, one or more metal salts can correspond to a metal oxide, metal hydroxide, metal carbonate, and/or metal acetate. In an aspect, the resulting metal organic framework is Mg/Mn-MOF-274, sometimes referred to as MOF-274 or EMM-67.

As described herein, some suitable linkers can be formed by two phenyl rings joined at carbon 1,1′ (i.e., a biphenyl type linkage), with carboxylic acids on carbons 3,3′, and alcohols on carbons 4,4′. This linker can be referred to as “H₄dobpdc”. In such aspects, switching the position of the carboxylic acids and the alcohols (e.g., “pc-H₄dobpdc” or “pc-MOF-274”) still allows for formation of a metal organic framework. In an aspect, the linker is H₄dobdpc.

In some aspects, the solvent environment can be substantially composed of and/or consist essentially of water (i.e., solvent environment is 99 vol % or more of water). In other aspects, the solvent can include 40 vol % to 99 vol % of water mixed with one or more alcohols. Examples of suitable alcohols include ethanol and isopropyl alcohol, although other C₄₋ alcohols (e.g., methanol and the isomers of propanol and n-butanol) can also be suitable. In still other aspects, the solvent can include 40 vol % to 99 vol % of water mixed with one or more other organic solvents. Tetrahydrofuran is an example of another potential solvent. More generally, organic solvents that are fully miscible with water can also be used. It is noted that some organic bases, such as pyridine or dimethyl formamide, may be able to serve as a solvent and/or a base.

Metal organic frameworks can be synthesized at room temperature, or using conventional electric heating, microwave heating, electrochemistry, mechanochemistry, and/or ultrasonic methods. Conventional step-by-step methods as well as high-throughput methods can be employed as well. In any synthesis, however, conditions must be established to produce defined inorganic building blocks without decomposition of an organic linker. At the same time, kinetics of crystallization must allow for nucleation and growth of the desired phase to take place.

The heating and sealing steps can include heating the reaction solution in static conditions for about 96 hours. The heating and sealing steps can include heating the reaction solution under dynamic (e.g. stirred, shaken, mixed, agitated) conditions for about 24 hours. The heating and sealing steps can include heating the reaction solution in a static oven at about 120° C. The heating and sealing steps can include heating the reaction solution in a rotating oven at about 150° C. The heating can be done without sealing, with the MOF synthesized with the solvent(s) at reflux under approximately 1 bar of pressure. In an aspect, the reaction solution is generally heated to 50° C. to 175° C. (or 100° C. to 160° C., or 115° C. to 145° C.) for 1 hour to 7 days, or 6 hours to 5 days, or 12 hours to 3 days. The reaction solution can be centrifuged or filtered to obtain the metal organic frameworks and washed.

In an aspect, the buffer comprises a Brønsted acid and its conjugate base, or a Brønsted base and its conjugate acid. In an aspect, the reaction solution or the reaction mixture is heated to between 25° C. and 160° C.

In an aspect, the reaction solution is subject to autogenous pressurization. In an aspect, the linker comprises multiple bridged aryl species having two or more phenyl rings or two phenyl rings joined by a vinyl group or an alkynyl group. In an aspect, the linker is H₄dobpdc. In an aspect, the metal salts are prepared by neutralization of acids or bases of a metal ion. In an aspect, the metal salts are Mg(NO₃)₂.6H₂O and MnCl₂.4H₂O. In an aspect, the buffer is Na MOPS. In an aspect, the metal organic frameworks comprise metal ions of one more distinct elements and a plurality of organic linkers, wherein each organic linker is connected to one of the metal ions of two or more distinct elements. In an aspect, the organic linker(s) correspond to disalicylate linker(s). In an aspect, the metal organic framework is MOF-274. In an aspect, nominal pH of the reaction solution allows for linker deprotonation. In an aspect, the solvent is selected by evaluation of Hansen solubility parameters. In an aspect, the reaction solution is heated in static conditions. In an aspect, the reaction solution is heated at about 120° C. In an aspect, the metal organic framework has an N₂ adsorption between about 25 mmol/g and about 45 mmol/g at relative pressure between about 0.1 and about 0.9. In an aspect, the metal organic framework produces powder x-ray diffraction peaks at 20 values between about 4° and about 6° and between about 7° and about 9°. In an aspect, the metal organic frameworks produce powder x-ray diffraction peaks at 20 values which are about equal to metal organic frameworks made by a traditional synthesis.

In an aspect, the metal organic frameworks provide an X-ray diffraction pattern having a unit cell that can be indexed to a hexagonal unit cell. In an aspect, the unit cell is selected from spacegroups 168 to 194 as defined in the International Tables for Crystallography. In an aspect, the present metal organic frameworks further comprise a metal rod structure composed of face-sharing octahedra, described by the Lidin-Andersson helix, as identified by Schoedel, Li, Li, O'Keeffe, and Yaghi, Chem Rev. 2016 116, 12466-12535. In an aspect, the metal organic framework has a hexagonal pore oriented parallel to the metal rod structure. In an aspect, the present metal organic frameworks display a (3,5,7)-c msi net, according to the approach described by Schoedel, Li, Li, O'Keeffe, and Yaghi, Chem Rev. 2016 116, 12466-12535. In an aspect, the metal organic framework displays a (3,5,7)-c msg net, according to the approach described by Schoedel, Li, Li, O'Keeffe, and Yaghi, Chem Rev. 2016 116, 12466-12535.

In an aspect, the subject metal organic frameworks express peak maxima in the X-ray diffraction pattern at 30° C. after drying at 250° C. under N₂ for 30 minutes at:

d(Å)
18.65 ± 0.5
10.79 ± 0.5
9.35 ± 0.5
7.07 ± 0.5
6.51 ± 0.5
6.24 ± 0.5
5.84 ± 0.5
5.41 ± 0.5
5.19 ± 0.5

In an aspect, the express peak maxima in the X-ray diffraction pattern at 30° C. after drying at 250° C. under N₂ for 30 minutes at:

d(Å)
18.65 ± 0.5
10.79 ± 0.5
7.07 ± 0.5
5.41 ± 0.5
5.19 ± 0.5

In an aspect, an A axis of the unit cell and a B axis of the unit cell are each greater than 18 Å, and a c axis is greater than 6 Å.

In various aspects, synthesizing MOFs in an aqueous environment and/or a solvent environment including 40 vol % or more of water can be advantageous, as such synthesis methods can reduce the cost and labor required in order to obtain high quality MOFs. Since the methods require less time and more material can be synthesized, the resulting methods can also provide more material available for testing and characterization and reduce the amount of time significantly, which can have a significant economic impact. Thus, aqueous synthesis and/or synthesis in a solvent environment including 40 vol % or more of water can represent a process intensification of MOF synthesis.

### Metal Organic Framework

In various aspects, methods are provided for forming metal organic framework compositions from an aqueous synthesis mixture or a synthesis mixture including a substantial portion of water. The metal organic framework can include a single metallic element, or the metal organic framework can correspond to a mixed-metal organic framework that includes a plurality of distinct metallic elements. The metallic element(s) in the metal organic framework can be bridged by a plurality of organic linkers, where each linker is connected to at least one metal ion.

In an example where a single metallic element (such as a single divalent metal ion) is used, the metal organic framework can be represented by the formula M¹₂A, wherein M¹ is a metal and A is an organic linker as described herein, such as one or more disalicylate linkers.

In another aspect, a mixed-metal organic framework can have the general Formula I:

M¹ₓM²₍₂₋ₓ₎(A) I

wherein M¹ is a metal and M² is a metal, but M¹ is not M²;

X is a value from 0 to 2, or 0.01 to 1.99; and

A is an organic linker as described herein, such as one or more disalicylate linkers.

In general, X can have any value between 0 and 2. It is noted that both X=0 and X=2 result in a metal organic framework that includes only a single metal. In an aspect, X is a value from 0.01 to 1.99. In an aspect, X is a value from 0.1 to 1. In an aspect, X is a value selected from the group consisting of 0.05, 0.1, 0.5 and 1. Further, while X and 2-X represent the relative ratio of M¹ to M², it should be understood that any particular stoichiometry is not implied in Formula I, Formula IA, Formula II or Formula III described herein. As such, the mixed-metal organic frameworks of the Formula I, IA, II or III are not limited to a particular relative ratio of M¹ to M². It is further understood that the metals are typically provided in ionic form and available valency will vary depending on the metal selected.

The metal of a metal organic framework as described herein (including a metal organic framework according to Formula I, IA, II, or III) can be one of the elements of Period 4 Groups IIA, IIIB, IVB, VB, VIB, VIIB, VIII, IB and IIB of the Periodic Table and Period 3 Group IIA including Mg, Ca, V, Mn, Cr, Fe, Co, Ni, Cu and Zn. Furthermore, in aspects where a plurality of metals are present, the mixed-metal organic framework can include two or more distinct elements as well as different combination of metals, theoretically represented as M¹ₓM²_{y} . . . Mⁿ_{z}(A)(B)₂ I x+y+ . . . +z=2 and M¹≠M²≠ . . . ≠Mⁿ.

In some aspects where only a single metal is present, the metal can be selected from Mg, V, Ca, Mn, Cr, Fe, Co, Ni, Cu and Zn. In some aspects where a plurality of metals are present, such as according to Formula I, M¹ can selected from Mg, V, Ca, Mn, Cr, Fe, Co, Ni, Cu and Zn; and M² can be selected from Mg, V, Ca, Mn, Cr, Fe, Co, Ni, Cu and Zn, provided that M¹ is not M². In another aspect, M¹ is selected from the group consisting of Mg, Mn, Ni and Zn; and M² is selected from the group consisting of Mg, Mn, Ni and Zn; provided M¹ is not M². In yet another aspect, M¹ is Mg and M² is Mn. In still another aspect, M¹ is Mg and M² is Ni. In yet another aspect, M¹ is Zn and M² is Ni. It is further understood that the metals are typically provided in an ionic form and the valency will vary depending on the metal selected. Further, the metals can be provided as a salt or in salt form.

Additionally or alternately, in aspects where the metal organic framework corresponds to a mixed-metal organic framework, at least one metal can be a monovalent metal that would make A the protonated form of the linker H-A. For example, the metal can be Na or one from Group I. Also, the metal can be one of two or more divalent cations (“divalent metals”) or trivalent cations (“trivalent metals”). In an aspect, the mixed metal mixed organic framework includes metals which are at oxidation states other than +2 can (i.e., more than just divalent, trivalent tetravalent, . . . ). The framework can have metals comprising a mixture of different oxidation states. Exemplary mixtures include Fe(II) and Fe(III), Cu(II) and Cu(I) and/or Mn(II) and Mn(III). More specifically, trivalent metals are metals having a +3 oxidation state. Some metals used to form the mixed-metal organic framework, specifically Fe and Mn, can adopt +2 (divalent) or +3 (trivalent) oxidation states under relatively gentle conditions. Chem. Mater, 2017, 29, 6181. Likewise, Cu(II) can form Cu(I) under gentle conditions. As such, any minor change to the oxidation state of any of the metals and/or selective change in the oxidation state of a metal can be used to modify the present mixed-metal organic frameworks. Furthermore, any combination of different molecular fragments C₁, C₂, . . . Cₙ may exist. Finally, all of the above variations can be combined, for example, multiple metals (two or more distinct metals) with multiple valences and multiple charge-balancing molecular fragments.

Suitable organic linkers (also referred to herein as “linkers”) can be determined from the structure of the mixed-metal organic framework and the symmetry operations that relate the portions of the organic linker that bind to the metal node of the mixed-metal organic framework. A linker which is chemically or structurally different, yet allows the metal node-binding regions to be related by a C₂ axis of symmetry, will form a mixed-metal organic framework of an identical topology. In an aspect, the organic linker can be formed by two phenyl rings joined at carbon 1,1′, with carboxylic acids on carbons 3, 3′, and alcohols on carbons 4,4′. Switching the position of the carboxylic acids and the alcohols (e.g., “pc-H₄dobpdc” described below) still allows for formation of a mixed-metal organic framework.

Generally, the linker can correspond to a disalicylate. A disalicylate corresponds to a linker that includes two monohydroxybenzoate groups.

In an aspect, useful linkers include:

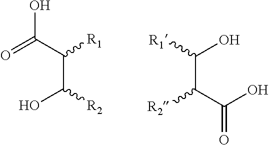

where R₁ is connected to R₁′ and R₂ is connected to R₂.″

Examples of such linkers include:

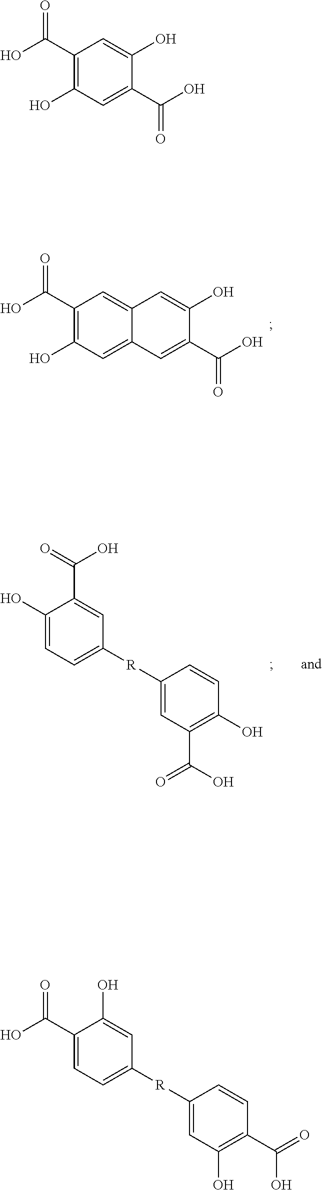

where R is any molecular fragment.

Examples of suitable organic linkers include para-carboxylate (“pc-linker”) such as 4,4′-dioxidobiphenyl-3,3′-dicarboxylate (DOBPDC); 4,4′-dioxido-[1,1′:4′,1″-terphenyl]-3,3′-dicarboxylate (DOTPDC); and dioxidobiphenyl-4,4′-dicarboxylate (3,3′-para-carboxylate-DOBPDC also referred to as pc-DOBPDC) as well as the following compounds:

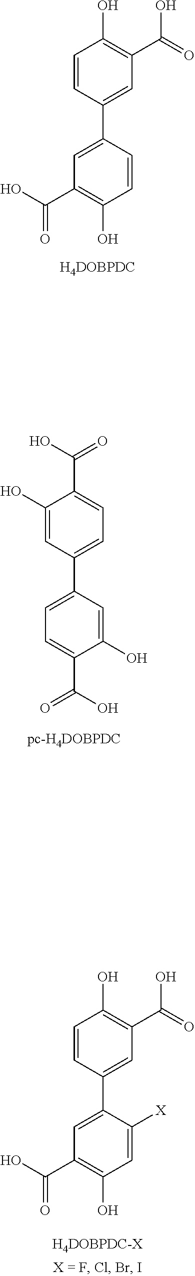

In an aspect, the organic linker has the formula:

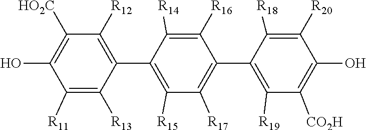

where R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl.

In an aspect, the organic linker has the formula:

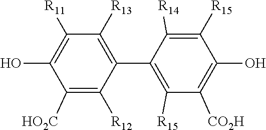

where, R₁₁, R₁₂, R₁₃, R₁₄, R₁₅, and R₁₆ are each independently selected from H, halogen, hydroxyl, methyl, and halogen substituted methyl.

In an aspect, the organic linker has the formula:

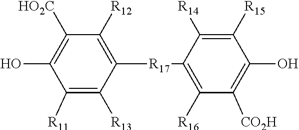

where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker has the formula:

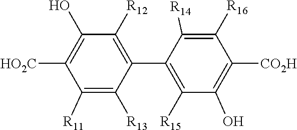

where R₁₁, R₁₂, R₁₃, R₁₄, R₁₅, and R₁₆ are each independently selected from H, halogen, hydroxyl, methyl, or halogen substituted methyl.

where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker includes multiple bridged aryl species such as molecules having two (or more) phenyl rings or two phenyl rings joined by a vinyl or alkynyl group.

In an aspect, a mixed-metal organic framework can correspond to structural Formula IA:

M¹ₓM²₍₂₋ₓ₎(A) IA

wherein M¹ is a metal independently selected from Mg, Ca, V, Mn, Cr, Fe, Co, Ni, Cu or Zn, or salt thereof;

M² is a metal independently selected from Mg, Ca, V, Mn, Cr, Fe, Co, Ni, Cu or Zn or salt thereof, but M¹ is not M²;

X is a value from 0.01 to 1.99; and

A is an organic linker as described herein.

As described herein, the mixed-metal mixed-organic frameworks are porous crystalline materials formed of two or more distinct metal cations, clusters, or chains joined by two or more multitopic (polytopic) organic linkers.

Chemical Buffers and/or Base Addition

In some aspects, solubility of the reagent is maximized by inclusion of a chemical buffer (referred to herein as a “buffer”), fixing nominal pH of the reaction solution to allow linker deprotonation and subsequent formation of the metal organic framework. The buffer can include an acid and its conjugate base, or a base and its conjugate acid. The buffers can be generated in situ by addition of the buffering acid followed by addition of a basic solution to the appropriate pH. Similarly, the buffers can be generated in situ by addition of the buffering base followed by addition of an acidic solution to the appropriate pH. In an aspect, the buffer can be 3-(N-morpholino)propanesulfonic acid (“MOPS”) or Na MOPS.

In other aspects, a base can be added to the water and/or water plus organic solvent environment, as opposed to adding an acid/base combination to form a buffer. In still other aspects, some solvents may be able to serve as both a base and a solvent. In such aspects, addition of a separate base or buffer is optional. Examples of such solvents can include, but are not limited to, pyridine and dimethyl formamide. In yet other aspects, if a metal oxide, metal hydroxide, metal carbonate, and/or metal acetate is used as a source of metal for forming the metal organic framework, addition of a separate base or buffer is optional.

Examples of suitable bases include, but are not limited to, piperazine, 1,4-dimethylpiperazine, pyridine, 2,6-lutidine, sodium hydroxide, potassium hydroxide, lithium hydroxide, various types of amines (primary, secondary, and/or tertiary), ammonium hydroxide and the like, and any combination thereof.

Examples of suitable acids include, but are not limited to, hydrochloric acid, nitric acid, citric acid, oxalic acid, malonic acid, succinic acid, glutaric acid, acetic acid, perchloric acid, phosphoric acid, phosphorus acid, sulfuric acid, formic acid, hydrofluoric acid, and the like, and any combination thereof.

Examples of suitable acids and conjugate bases, and suitable bases and conjugate acids which are used to buffer the nominal pH include, but are not limited to, acetic acid/acetate, citric acid/citrate, boric acid/borate, and the like, the buffers known as “Good Buffers” defined in Biochemistry, 1966, 5, 467-477, incorporated herein by reference, and the noncomplexing tertiary amine buffers known as “Better Buffers” defined in Anal Chem., 1999, 71, 3140-3144, incorporated herein by reference.

Buffers can include potential variations on MOPS and can be of the formula:

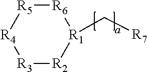

wherein n=is an integer between 1 and 10, and any atoms bridging R₁ and R₇ can be functionalized with chemical substituents, or “R” as defined in paragraphs [0027 through [0030], [0032], and [0033] above;

R₁, R₂, R₃, R₄, R₅, and R₆ are each independently C, O, N or S; and

R₇ is any Brøsted acid functional group or corresponding conjugate base, sulfonic acid, phosphonic acid and/or sulfoxylate, phosphonate, phosphate, hydroxyl, ammonia, or sulfate.

### Variations on MOF Structures

MOF-274 is an example of a type of MOF that can be synthesized using disalicylate linkers. The traditional MOF-274 structure corresponds to M₂(dobpdc) where M=various 2+ metal ions. Many variations of MOF-274 can be formed that also correspond to metal organic framework materials. Examples of these variations are described here for MOF-274, but it is understood that this is to illustrate the nature of the variations. Thus, similar variations on other types of metal organic framework materials that also include disalicylate linkers are also contemplated herein.

In some aspects, one type of variation corresponds to MₓN₂₋ₓ(dobpdc), where M and N are different 2+ metal ions. This represents a variation where two different types of divalent metal ions are included in the metal organic framework material. Another variation can be to have more than two different types of divalent metal ions. Still another variation can be to have a plurality of metal ions, with some metal ions having an oxidation state different from 2+. Yet another variation corresponds to M_{x-y}N_{2-x-z}(dobpdc)_{1-y} where M and N are the same or different 2+ metal ions, z and y are <2, and the structure contains defects in the form of missing metals. Yet another variation corresponds to M_{x-2y}N_{2-x-2y}(dobpdc)_{1-y} where M and N are the same or different 2+ metal ions, x may be 0-2, and y may be 0-1.

In some aspects, a type of variation corresponds to MₓN₂₋ₓ(dobpdc)_{1-y} where M and N are the same or different 2+ metal ions and the structure contains defects in the form of missing linkers, where x may be 0-2 and y may be 0-1. Another type of variation corresponds to MₓN₂₋ₓ(dobpdc)_{1-y}A where M and N are the same or different 2+ metal ions and the structure contains defects in the form of missing linkers and A is a charge balancing anion (e.g. Cl⁻, F⁻, Br⁻, OH⁻, NO₃⁻). Yet another type of variation corresponds to MₓN₂₋ₓ(dobpdc)_{1-y}A_{y} where M and N are the same or different 2+ metal ions and the structure contains defects in the form of missing linkers and A is a charge balancing anion (e.g. Cl⁻, F⁻, Br⁻, OH⁻, NO₃⁻), x may be 0-2, and y may be 0-1. Yet another type of variation corresponds to M_{x-y}N_{2-y}(dobpdc)Z, where M and N are the same or different 2+ metal ions and the structure contains defects in the form of missing linkers and Z is a charge balancing cation (e.g. H⁺, Na⁺, K⁺). Yet another type of variation corresponds to M_{x-y}N_{2-x-y}(dobpdc)Z_{y}, where M and N are the same or different 2+ metal ions and the structure contains defects in the form of missing linkers and Z is a charge balancing cation (e.g. H⁺, Na⁺, K⁺), x may be 0-2, and y may be 0-1.

In some aspects, a type of variation corresponds to MₓN₂₋ₓ(dobpdc)Sol_{0.1-2} where M and N are the same or different 2+ metal ions and the structure contains defects in the form of missing linkers and Sol is a coordinating monodentate ligand (such as OH₂, MeOH, DMF, MeCN, THF, NR₃, HNR₂, H₂NR). Another type of variation corresponds to MₓN₂₋ₓ(dobpdc)Sol_{0.05-1} where M and N are the same or different 2+ metal ions and the structure contains defects in the form of missing linkers and Sol is a coordinating bidentate ligand. Another type of variation corresponds to MₓN₂₋ₓ(dobpdc)_{1-y}Sol_{2-y}, where M and N are the same or different 2+ metal ions and the structure contains defects in the form of missing linkers and Sol is a coordinating bidentate ligand and y may be 0-0.5 such as 0.1.

### Example 1— Formation of EMM-44 by Addition of 2-Ampd to EMM-67 Synthesis Solution

In this example, an amine-appended MOF composition (EMM-44) is formed by first forming an intermediate product mixture containing the MOF EMM-67, followed by adding 2-aminomethylpiperidine (2-ampd) to the intermediate product mixture.

Synthesis of EMM-67: In 8 mL DI H₂O, 0.309 g (0.0077 mol) of NaOH pellets were dissolved. To this solution, 0.532 g (1.933 mmol) H₄dobpdc were added and stirred thoroughly. To a separate 8 mL DI H₂O, 1.176 g (4.579 mmol) Mg(NO₃)₂.6H₂O and 0.05 g (0.252 mmol) MnCl₂.4H₂O were added and stirred until dissolution. The metal-containing solution and the linker-containing suspension were slowly combined and stirred until all reagents were well dispersed. The reaction mixture was transferred to a 23-mL Teflon-lined autoclave, sealed, and placed in a 120° C. autoclave for 24 hours under static conditions to form an intermediate product mixture containing EMM-67. The intermediate product mixture was then allowed to cool naturally to room temperature.

Amine addition to prepare EMM-44: To the nascent EMM-67 synthesized above, 2 mL of 2-aminomethylpiperidine (2-ampd) was added to the intermediate product mixture. The system was mixed thoroughly and allowed to sit for 24 hours under static conditions, after which the diamine appended MOF EMM-44 was collected by centrifugation.

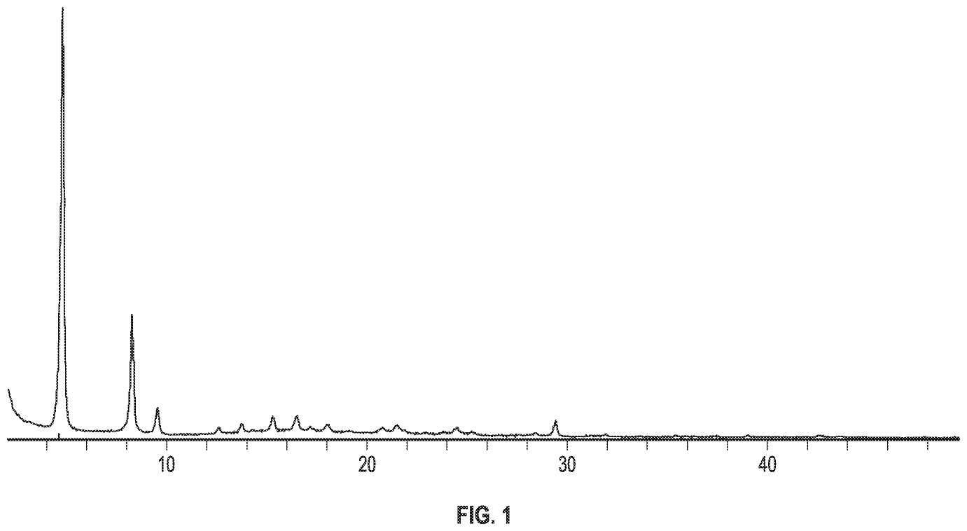

The resulting EMM-44 was analyzed in several ways. One analysis was to confirm the presence of the crystal structure for EMM-67, the underlying non-appended version of the MOF. FIG. 1 shows a powder X-ray diffraction (PXRD) spectrum of the EMM-44 generated by the above procedure. The peaks shown in FIG. 1 correspond to EMM-67, indicating that the crystal structure of the EMM-67 was not disrupted by addition of amines to the intermediate product mixture.

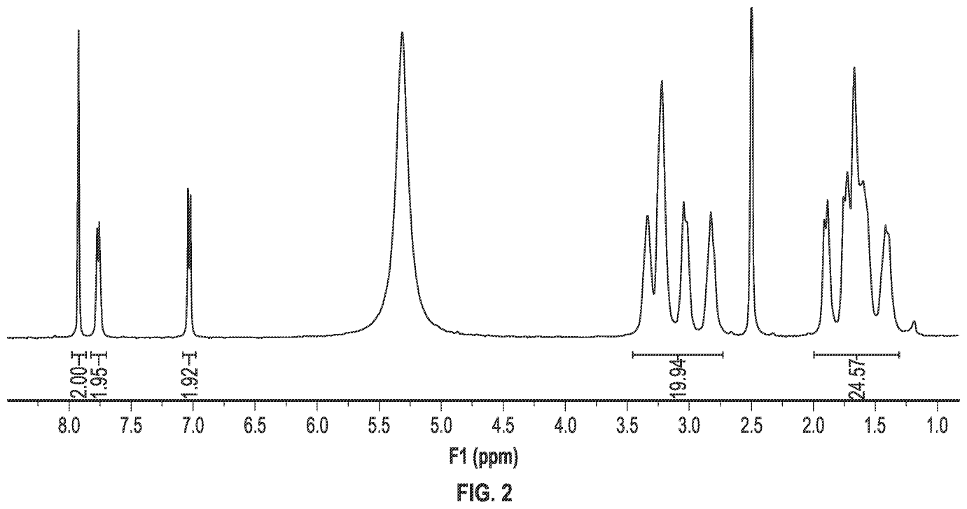

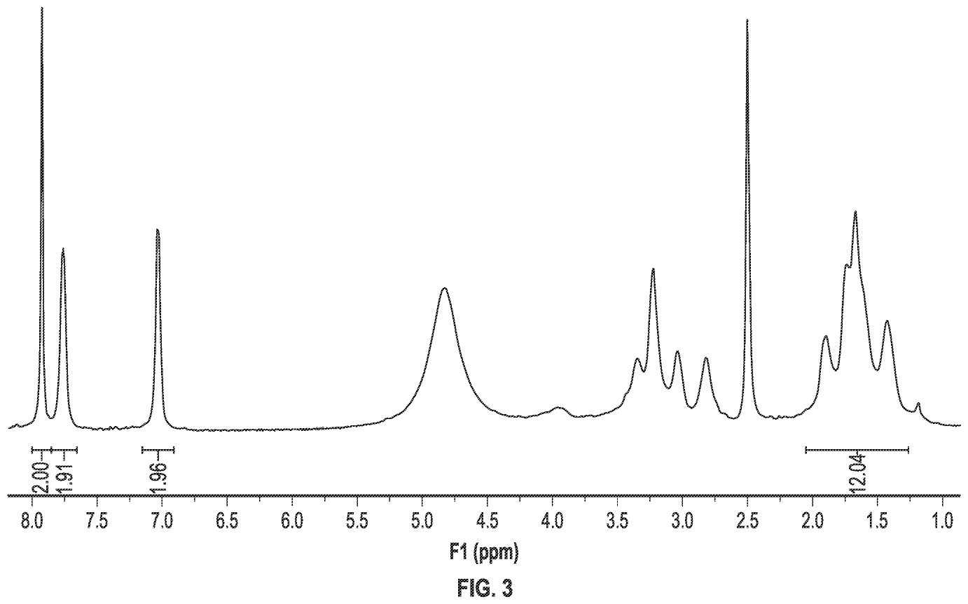

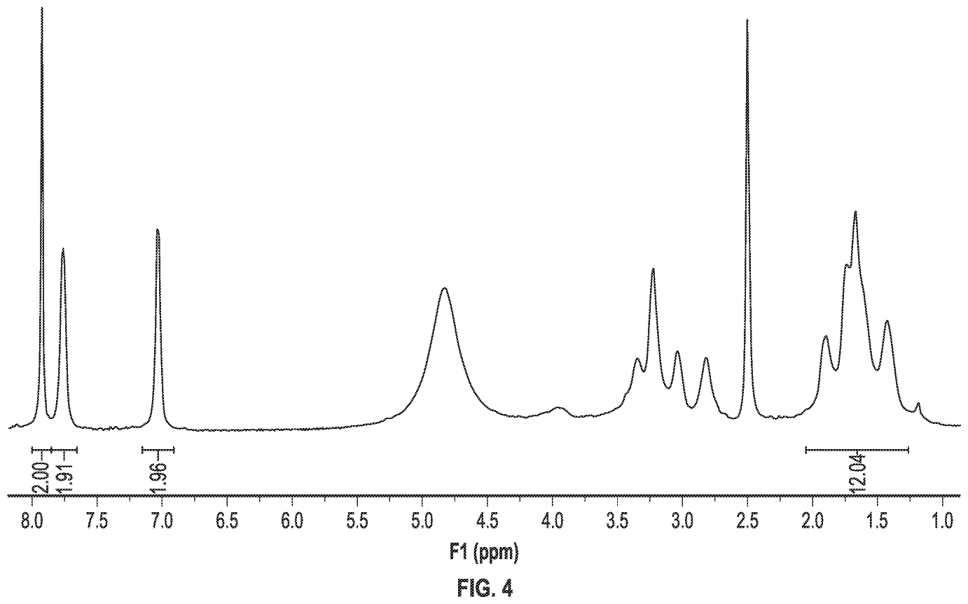

Another type of characterization was to determine amine loading by using ¹H NMR on samples digested in solution at the various stages described below and produced spectra of FIGS. 2-5. The diamine proton integrations were compared against those of the MOF linker, affording quantification of the amine loading. FIG. 2 shows a ¹H NMR spectrum for the EMM-44 as collected after centrifugation. FIG. 3 shows a ¹H NMR spectrum for the EMM-44 after heating of the EMM-44 at 120° C. for 18.5 hours under air. The spectra in FIG. 2 and FIG. 3 were integrated to compare the amount of appended amines (peaks between 1.25 to 2.0 ppm) to the amount of linker (peaks between 7.0 to 8.0 ppm) in the EMM-44 samples. Based on this integration, it was determined that FIG. 2 showed an initial loading of amines in the sample that was 205% of the amount of linker in the MOF. After heating, it was determined that FIG. 3 showed a final loading 109% of the amount of linker. Because the NMR still indicated an appended amine loading in excess of the idealized “100%” loading, an additional half hour of heating was performed at 120° C. followed by NMR analysis of the additionally heated sample. After the additional heating, integration of peaks from the resulting NMR spectrum (shown in FIG. 4) indicated a roughly 100% loading of appended amines, which is what would be expected for fully amine-appended EMM-44. This roughly 100% loading was further confirmed by a separate thermogravimetric analysis.

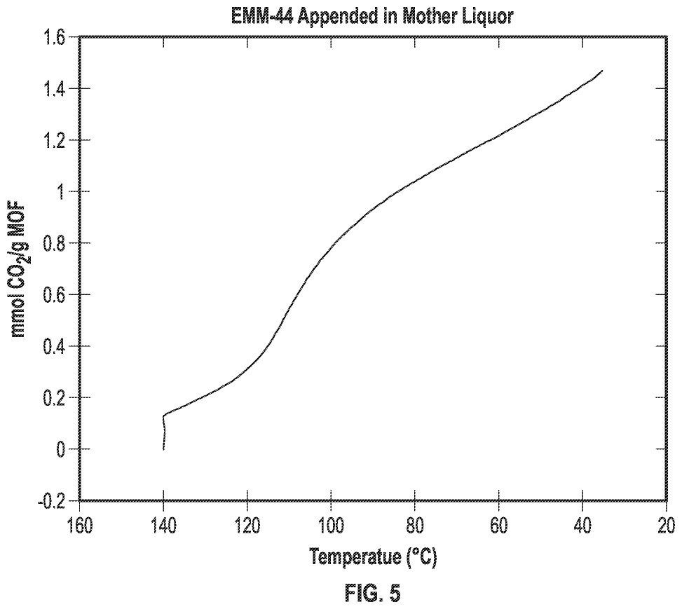

Still another characterization was to characterize the CO₂ adsorption isobar for the EMM-44 material. As shown in FIG. 5, the EMM-44 material shows a stepped Type V isobar, as would be expected for the amine-appended material.

### Example 2—Formation of EMM-53 by Addition of N¹,N^{1′}-(Butane-1,4-Diyl)Bis(Propane-1,3-Diamine) to EMM-67 Synthesis Solution

An intermediate product mixture containing EMM-67 was formed according to the method described in Example 1.

Appending with N¹,N^{1′}-(butane-1,4-diyl)bis(propane-1,3-diamine) to form EMM-53 (3-4-3): After the EMM-67 system cooled naturally to room temperature, the entire contents were transferred to a 30-mL centrifuge tube and heated to 60° C. Separately, several grams of N¹,N^{1′}-(butane-1,4-diyl)bis(propane-1,3-diamine) were heated to 60° C. in the oven. 1 mL of N¹,N^{1′}-(butane-1,4-diyl)bis(propane-1,3-diamine) was transferred to the EMM-67 and synthesis solution, mixed well, then allowed to sit in a static configuration for 24 hrs at 60° C. The solids were then collected by centrifugation while still warm, and washed once with 60° C. toluene.

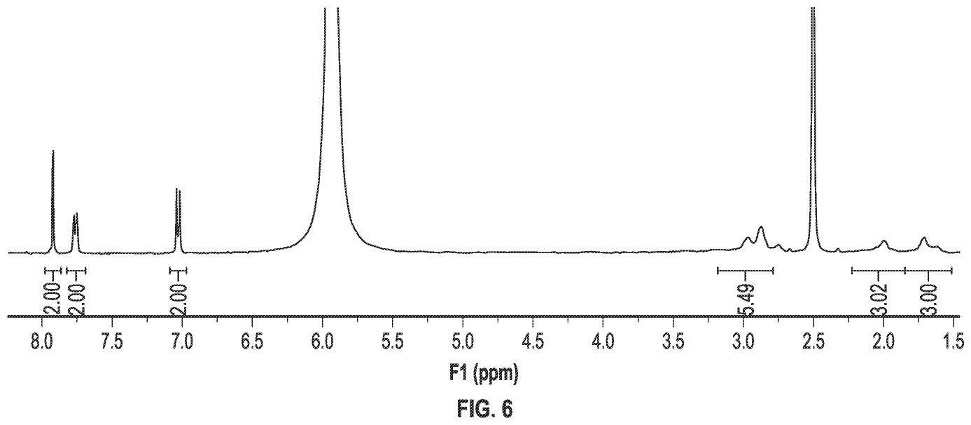

The solids were then digested and characterized by ¹H NMR. The resulting ¹H NMR spectrum is shown in FIG. 6. The spectrum was integrated to compare the amount of appended amines (peaks between 1.25 to 2.0 ppm) to the amount of linker (peaks between 7.0 to 8.0 ppm) in the EMM-53 (3-4-3) sample. Based on this integration, it was determined that the appended amine content was 75% of the amount of linker.

### Example 3—Formation of EMM-53 by Addition of N¹,N^{1′}-(Ethane-1,2-Diyl)Bis(Propane-1,3-Diamine to EMM-67 Synthesis Solution

An intermediate product mixture containing EMM-67 was formed according to the method described in Example 1. Another type of tetraamine, N¹,N^{1′}-(ethane-1,2-diyl)bis(propane-1,3-diamine), was then added to the intermediate product mixture to perform amine appending.

Appending with N¹,N^{1′}-(ethane-1,2-diyl)bis(propane-1,3-diamine) was performed in the same manner as described in Example 2, with the following exception. Because N¹,N^{1′}-(ethane-1,2-diyl)bis(propane-1,3-diamine) is a liquid at room temperature, the intermediate product mixture and the N¹,N^{1′}-(ethane-1,2-diyl)bis(propane-1,3-diamine) were at room temperature when the amine was added to the intermediate product mixture. After amine addition, the solution was maintained at room temperature for the 24 hour period. The solids were then collected by centrifugation.

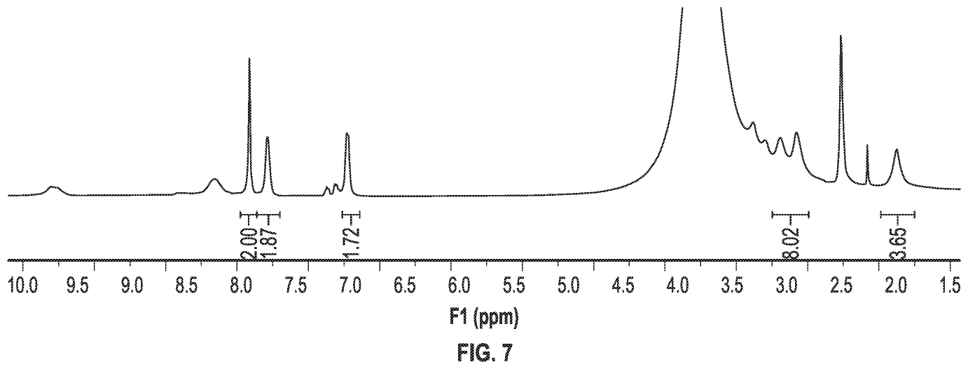

The solids digested in solution were then characterized by ¹H NMR. The resulting ¹H NMR spectrum is shown in FIG. 7. The spectrum was integrated to compare the amount of appended amines (peaks between 1.25 to 2.0 ppm) to the amount of linker (peaks between 7.0 to 8.0 ppm) in the EMM-53 (3-2-3) sample. Based on this integration, it was determined that the appended amine content was 91% of the amount of linker.

### Example 4— Preparation of EMM-44 in Protic Solvents from Previously Synthesized EMM-67

100 mg of EMM-67, synthesized and isolated previously, was washed two times with ethanol, then suspended in 10 mL of 25% (v/v) 2-ampd solution in ethanol. The EMM-67 was swirled gently in solution, then allowed to sit in a static configuration at room temperature for 24 hrs. The appended material was removed by centrifugation and washed in toluene. The resulting materials were characterized by PXRD and digested in solution for ¹H NMR. It is noted that a similar material was made using water as the protic solvent instead of ethanol.

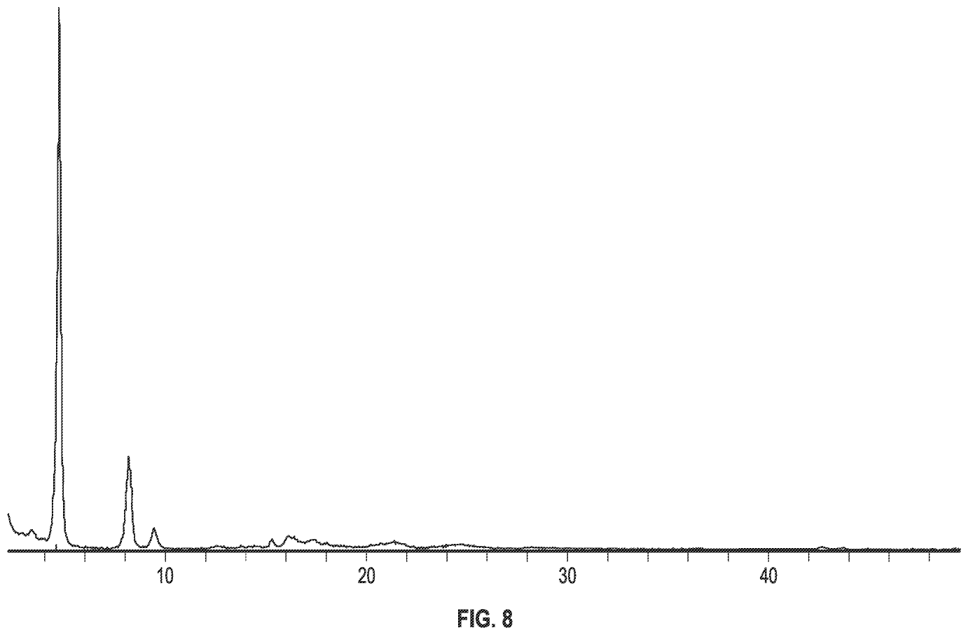

FIG. 8 shows the PXRD spectrum of the EMM-44 material formed using the 2-ampd solution in ethanol. As shown in FIG. 8, the structure of EMM-67 was retained after appending the 2-ampd to form EMM-44.

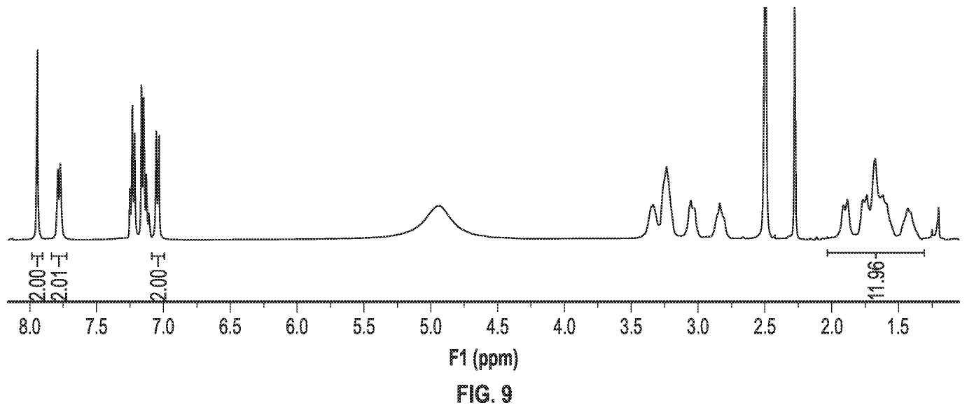

FIG. 9 shows the ¹H NMR spectrum for the EMM-44. The spectrum was integrated to compare the amount of appended amines (peaks between 1.25 to 2.0 ppm) to the amount of linker (peaks between 7.0 to 8.0 ppm) in the EMM-44 sample. Based on this integration, it was determined that the appended amine content was roughly 100% of the amount of linker.

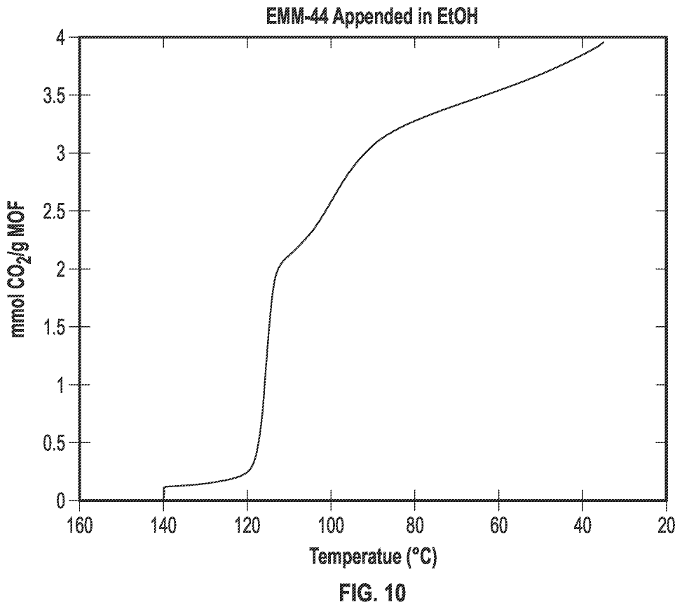

It is further noted that a CO₂ adsorption isobar for the material showed the expected stepped Type V isobar. The CO₂ adsorption isobar for this material is shown in FIG. 10.

### Example 5— Preparation of EMM-53 in Protic Solvents from Previously Synthesized EMM-67

100 mg of EMM-67, synthesized and isolated previously, was washed two times with ethanol, then suspended in 10 mL of 25% (v/v) N¹,N^{1′}-(butane-1,4-diyl)bis(propane-1,3-diamine) solution in ethanol pre-heated at 60° C. The EMM-67 was swirled gently in solution, then allowed to sit in a static configuration at 60° C. for 24 hrs. The appended material was removed by centrifugation and washed with 60° C. toluene. The resulting materials were characterized by PXRD and ¹H NMR.

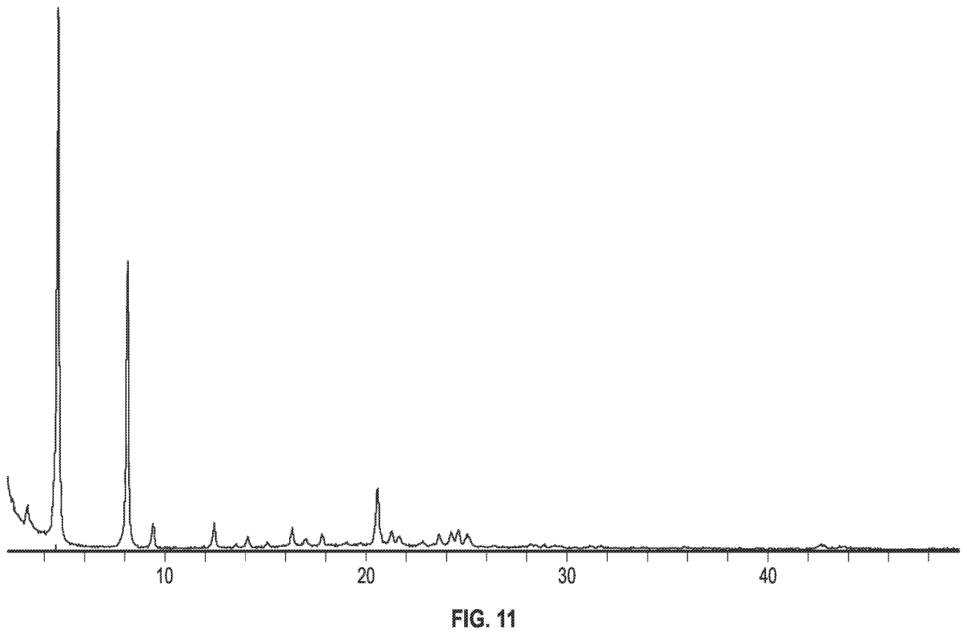

FIG. 11 shows the PXRD spectrum of the EMM-53 material formed using the N¹,N^{1′}-(butane-1,4-diyl)bis(propane-1,3-diamine) solution in ethanol. As shown in FIG. 10, the structure of EMM-67 was retained after appending the N¹,N^{1′}-(butane-1,4-diyl)bis(propane-1,3-diamine) to form EMM-53.

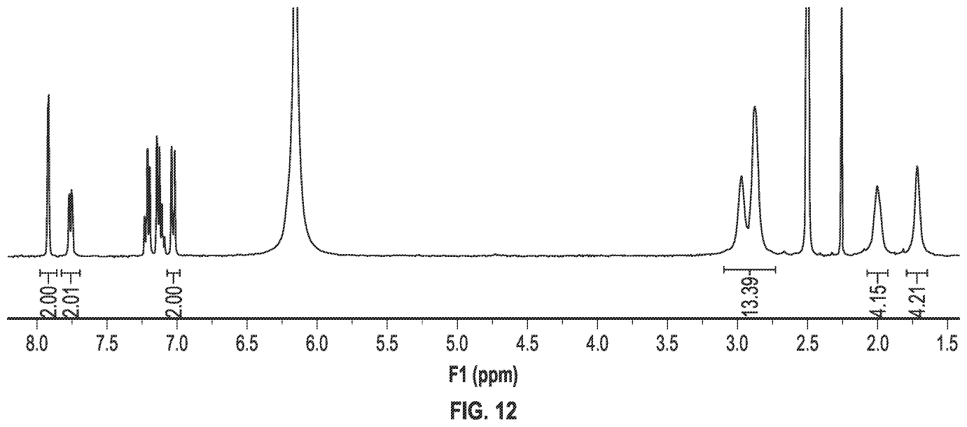

FIG. 12 shows the ¹H NMR spectrum for the EMM-53 using digested samples in solution. The spectrum was integrated to compare the amount of appended amines (peaks between 1.25 to 2.0 ppm) to the amount of linker (peaks between 7.0 to 8.0 ppm) in the EMM-53 sample. Based on this integration, it was determined that the appended amine content was roughly 105% of the amount of linker.

It is further noted that a CO₂ adsorption isobar for the material showed the expected stepped Type V isobar.

### Example 6—Additional Impurity Peaks

Depending on the nature of the synthesis mixture, the reaction conditions (including temperature and mixing rate), and the reaction time, the MOF compositions formed by the methods described herein can be used to form either pure phase MOF crystals or to form a product that includes some amount of impurities. One type of impurity that can be visible in a PXRD pattern is an impurity due to incomplete reaction of a reagent, such as incomplete reaction of a metal compound. Another type of impurity can correspond to a salt that is formed from a) a metal introduced as part of a separate base in the synthesis mixture and b) the counter-ion of a metal compound in the synthesis mixture. Depending on the aspect, such impurities can correspond to 20 wt % or less of the product formed from a synthesis mixture, or 10 wt % or less, or 5.0 wt % or less, such as down to having substantially no impurities.

The following tables show examples of potential peak locations for impurities that may be associated with formation of metal organic framework structure compositions, such as MOF-274 (including EMM-67). Tables 1-4 provide potential peak locations based on impurities corresponding to MgCO₃ (Table 1), MgO (Table 2), Mg(OH)₂ (Table 3), and NaNO₃.

TABLE 1
MgCO₃

| Peak Location (2Θ) | STD Range (2Θ) |
|---|---|
| 32.631 | +/−0.3 |
| 35.847 | +/−0.3 |
| 38.818 | +/−0.3 |
| 42.995 | +/−0.3 |
| 46.815 | +/−0.3 |
| 51.627 | +/−0.3 |
| 53.887 | +/−0.3 |
| 61.345 | +/−0.3 |
| 62.352 | +/−0.3 |
| 66.441 | +/−0.3 |
| 68.368 | +/−0.3 |
| 69.348 | +/−0.3 |
| 70.298 | +/−0.3 |
| 75.94 | +/−0.3 |
| 76.911 | +/−0.3 |
| 79.694 | +/−0.3 |
| 81.522 | +/−0.3 |
| 83.368 | +/−0.3 |
| 85.978 | +/−0.3 |
| 88.785 | +/−0.3 |
| 92.439 | +/−0.3 |
| 94.263 | +/−0.3 |
| 98.802 | +/−0.3 |
| 105.268 | +/−0.3 |
| 107.154 | +/−0.3 |
| 109.115 | +/−0.3 |
| 113.937 | +/−0.3 |
| 114.986 | +/−0.3 |
| 118.978 | +/−0.3 |
| 121.307 | +/−0.3 |
| 123.172 | +/−0.3 |
| 126.503 | +/−0.3 |
| 131.153 | +/−0.3 |
| 134.723 | +/−0.3 |
| 137.496 | +/−0.3 |
| 149.663 | +/−0.3 |

TABLE 2
MgO

| Peak Location (2Θ) | STD Range (2Θ) |
|---|---|
| 36.937 | +/−0.3 |
| 42.917 | +/−0.3 |
| 62.303 | +/−0.3 |
| 74.691 | +/−0.3 |
| 78.63 | +/−0.3 |
| 94.051 | +/−0.3 |
| 105.733 | +/−0.3 |
| 109.764 | +/−0.3 |
| 127.284 | +/−0.3 |
| 143.752 | +/−0.3 |

TABLE 3
Mg(OH)₂

| Peak Location (2Θ) | STD Range (2Θ) |
|---|---|
| 18.785 | +/−0.3 |
| 31.138 | +/−0.3 |
| 36.65 | +/−0.3 |
| 38.1 | +/−0.3 |
| 49.903 | +/−0.3 |
| 55.368 | +/−0.3 |
| 58.971 | +/−0.3 |
| 64.982 | +/−0.3 |
| 67.749 | +/−0.3 |
| 68.198 | +/−0.3 |
| 69.231 | +/−0.3 |
| 77.774 | +/−0.3 |
| 81.338 | +/−0.3 |
| 84.741 | +/−0.3 |
| 89.411 | +/−0.3 |
| 90.462 | +/−0.3 |
| 92.992 | +/−0.3 |
| 102.602 | +/−0.3 |

TABLE 4
NaNO₃

| Peak Location (2Θ) | STD Range (2Θ) |
|---|---|
| 22.821 | +/−0.3 |
| 29.378 | +/−0.3 |
| 31.867 | +/−0.3 |
| 35.358 | +/−0.3 |
| 38.93 | +/−0.3 |
| 42.5 | +/−0.3 |
| 46.627 | +/−0.3 |
| 47.911 | +/−0.3 |
| 48.351 | +/−0.3 |
| 55.581 | +/−0.3 |
| 56.464 | +/−0.3 |
| 59.859 | +/−0.3 |
| 60.965 | +/−0.3 |
| 61.573 | +/−0.3 |
| 62.322 | +/−0.3 |
| 63.5 | +/−0.3 |
| 66.646 | +/−0.3 |
| 68.677 | +/−0.3 |
| 70.469 | +/−0.3 |
| 72.491 | +/−0.3 |
| 74.854 | +/−0.3 |
| 77.77 | +/−0.3 |
| 81.372 | +/−0.3 |
| 82.363 | +/−0.3 |
| 83.627 | +/−0.3 |
| 86.455 | +/−0.3 |
| 90.05 | +/−0.3 |
| 92.962 | +/−0.3 |
| 93.897 | +/−0.3 |
| 97.358 | +/−0.3 |
| 97.755 | +/−0.3 |
| 99.07 | +/−0.3 |

### Additional Embodiments

Embodiment 1. A method of making an amine-appended metal organic framework composition, comprising: dissolving a plurality of solid reagents in a solvent to provide a synthesis solution, the plurality of solid reagents comprising at least one metal salt and at least one organic linker, the plurality of solid reagents comprising at least one of a base or a buffer; heating the synthesis solution to form an intermediate product mixture comprising a metal organic framework; and adding one or more polyamines to the intermediate product mixture to form an amine-appended metal organic framework, the solvent in the intermediate product mixture comprising 50 vol % or more of water, an alcohol, or a combination thereof, after addition of the one or more polyamines, wherein the metal organic framework comprises the metal of the at least one metal salt and the organic linker.

Embodiment 2. The method of Embodiment 1, wherein the synthesis solution comprises 40 vol % or more of water, or wherein the solvent comprises 99 vol % or more of water, or a combination thereof.

Embodiment 3. The method of any of the above embodiments, wherein the organic linker comprises a multi-ring disalicylate organic linker.

Embodiment 4. The method of Embodiment 3, wherein a plurality of rings in the multi-ring disalicylate organic linker comprise a salicylate functional group; or wherein a plurality of rings in the multi-ring disalicylate organic linker are connected by at least one of a biphenyl linkage, a vinyl linkage, and an alkyl linkage; or wherein the linker is 4,4′-dihydroxy-[1,1′-biphenyl]-3,3′-dicarboxylic acid; or a combination thereof.

Embodiment 5. The method of Embodiment 3 or 4, wherein the metal organic framework is of the formula: M¹₂(A) where M¹ comprises a metal cation, and A comprises a multi-ring disalicylate organic linker, or wherein the metal organic framework is of the formula: M¹ₓM²₍₂₋ₓ₎(A) where M¹ and M² comprise metal cations, x ranges from 0 to 2, and A comprises a multi-ring disalicylate organic linker.

Embodiment 6. The method of claim 1, i) wherein the intermediate product mixture comprises 50 vol % or more of water, alcohol, or a combination thereof, the alcohol optionally comprising ethanol, isopropyl alcohol, or a combination thereof; ii) wherein the synthesis solution comprises 50 vol % or more of water, an alcohol, or a combination thereof; or iii) a combination of i) and ii).

Embodiment 7. The method of any of the above embodiments, wherein the at least one metal salt comprises a metal oxide, the metal oxide comprising at least a portion of the at least one of a base or a buffer; or wherein the at least one metal salt comprises a hydroxide, a carbonate, an acetate, or a combination thereof, the at least one metal salt comprising at least a portion of the at least one of a base or a buffer; or a combination thereof.

Embodiment 8. The method of any of the above embodiments, wherein the base comprises an organic base.

Embodiment 9. The method of any of the above embodiments, wherein the synthesis solution comprises a molar ratio of the at least one linker to metal from the at least one metal salt of 0.20 to 0.60.

Embodiment 10. The method of any of the above embodiments, A) wherein the synthesis solution comprises a combined concentration of metals plus linkers of 2.1 moles or more per liter of solvent; B) wherein the plurality of solid reagents comprise 0.1 wt % to 40 wt % of a weight of the synthesis solution; or C) a combination of A) and B).

Embodiment 11. The method of any of the above embodiments, wherein the plurality of solid reagents comprise a plurality of metal salts, the plurality of metal salts comprising at least one magnesium salt and at least one manganese salt.

Embodiment 12. The method of any of the above embodiments, wherein the metal organic framework comprises MOF-274, EMM-67, or a combination thereof.

Embodiment 13. The method of any of the above embodiments, wherein the synthesis solution is heated to between 50° C. and 175° C.

Embodiment 14. A method of making an amine-appended metal organic framework composition, comprising: washing a metal organic framework comprising a multi-ring disalicylate organic linker using a wash solvent to form a washed metal organic framework, the wash solvent comprising 90 vol % or more of one or more protic solvents, the washing comprising exposing the metal organic framework to the wash solvent two times or less; and exposing at least a portion of the washed metal organic framework to an appending solution by forming a suspension of the at least a portion of the washed metal organic framework in the appending solution, the appending solution comprising one or more protic solvents and one or more polyamines, wherein the appending solution comprises 50 vol % or more of water, an alcohol, or a combination thereof, the wash solution optionally being different from the one or more protic solvents in the appending solution.

Embodiment 15. The method of Embodiment 14, further comprising: dissolving a plurality of solid reagents in a solvent to provide a synthesis solution, the plurality of solid reagents comprising at least one metal salt and at least one organic linker, the plurality of solid reagents comprising at least one of a base or a buffer; heating the synthesis solution to form an intermediate product mixture comprising the metal organic framework; separating the metal organic framework from the intermediate product mixture; and drying the separated metal organic framework.

Additional Embodiment A. The method of Embodiment 5, wherein M¹ and M² comprise different metallic elements, or wherein A comprises a plurality of multi-ring disalicylate organic linkers, or wherein at least one of M¹ and M² comprises a divalent metal ion, or a combination thereof.

Additional Embodiment B. The method of any of the above embodiments, wherein the one or more polyamines comprise a diamine, a tetraamine, or a combination thereof.

Additional Embodiment C. The method of any of the above embodiments, wherein the synthesis solution further comprises dispersed solids, wherein the dispersed solids comprise one or more solid reagents from the plurality of solid reagents.

Additional Embodiment D. An amine-appended metal organic framework made according to the method of any of Embodiments 1 to 15.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A method of making an amine-appended metal organic framework composition, comprising:
dissolving a plurality of solid reagents in a solvent to provide a synthesis solution, the plurality of solid reagents comprising at least one metal salt and at least one organic linker, the plurality of solid reagents comprising at least one of a base or a buffer;
heating the synthesis solution to form an intermediate product mixture comprising a metal organic framework; and
adding one or more polyamines to the intermediate product mixture to form an amine-appended metal organic framework, the solvent in the intermediate product mixture comprising 50 vol % or more of water, an alcohol, or a combination thereof, after addition of the one or more polyamines,
is wherein the metal organic framework comprises the metal of the at least one metal salt and the organic linker.

2. The method of claim 1, wherein the synthesis solution comprises 40 vol % or more of water, or wherein the solvent comprises 99 vol % or more of water, or a combination thereof.

3. The method of claim 1, wherein the organic linker comprises a multi-ring disalicylate organic linker.

4. The method of claim 3, wherein a plurality of rings in the multi-ring disalicylate organic linker comprise a salicylate functional group; or wherein a plurality of rings in the multi-ring disalicylate organic linker are connected by at least one of a biphenyl linkage, a vinyl linkage, and an alkyl linkage; or wherein the linker is 4,4′-dihydroxy-[1,1′-biphenyl]-3,3′-dicarboxylic acid; or a combination thereof.

5. The method of claim 3, wherein the metal organic framework is of the formula: M¹₂(A) where M¹ comprises a metal cation, and A comprises a multi-ring disalicylate organic linker, or
wherein the metal organic framework is of the formula: M¹ₓM²₍₂₋ₓ₎(A) where M¹ and M² comprise metal cations, x ranges from 0 to 2, and A comprises a multi-ring disalicylate organic linker.

6. The method of claim 5, wherein M¹ and M² comprise different metallic elements, or wherein A comprises a plurality of multi-ring disalicylate organic linkers, or wherein at least one of M¹ and M² comprises a divalent metal ion, or a combination thereof.

7. The method of claim 1, wherein the intermediate product mixture comprises 50 vol % or more of water, alcohol, or a combination thereof, the alcohol optionally comprising ethanol, isopropyl alcohol, or a combination thereof.

8. The method of claim 1, wherein the synthesis solution comprises 50 vol % or more of water, an alcohol, or a combination thereof.

9. The method of claim 1, wherein the one or more polyamines comprise a diamine, a tetraamine, or a combination thereof.

10. The method of claim 1, wherein the at least one metal salt comprises a metal oxide, the metal oxide comprising at least a portion of the at least one of a base or a buffer; or wherein the at least one metal salt comprises a hydroxide, a carbonate, an acetate, or a combination thereof, the at least one metal salt comprising at least a portion of the at least one of a base or a buffer; or a combination thereof.

11. The method of claim 1, wherein the synthesis solution comprises a combined concentration of metals plus linkers of 2.1 moles or more per liter of solvent, or wherein the plurality of solid reagents comprise 0.01 wt % to 40 wt % of a weight of the synthesis solution, or a combination thereof.

12. The method of claim 1, wherein the base comprises an organic base.

13. The method of claim 1, wherein the synthesis solution comprises a molar ratio of the at least one linker to metal from the at least one metal salt of 0.20 to 0.60.

14. The method of claim 1, wherein the synthesis solution further comprises dispersed solids, wherein the dispersed solids comprise one or more solid reagents from the plurality of solid reagents.

15. The method of claim 1, wherein the plurality of solid reagents comprise a plurality of metal salts, the plurality of metal salts comprising at least one magnesium salt and at least one manganese salt.

16. The method of claim 1, wherein the metal organic framework comprises MOF-274, EMM-67, or a combination thereof.

17. The method of claim 1, wherein the synthesis solution is heated to between 50° C. and 175° C.

18. A method of making an amine-appended metal organic framework composition, comprising:
washing a metal organic framework comprising a multi-ring disalicylate organic linker using a wash solvent to form a washed metal organic framework, the wash solvent comprising 90 vol % or more of one or more protic solvents, the washing comprising exposing the metal organic framework to the wash solvent two times or less; and
exposing at least a portion of the washed metal organic framework to an appending solution by forming a suspension of the at least a portion of the washed metal organic framework in the appending solution, the appending solution comprising one or more protic solvents and one or more polyamines,
wherein the appending solution comprises 50 vol % or more of water, an alcohol, or a combination thereof.

19. The method of claim 18, further comprising:
dissolving a plurality of solid reagents in a solvent to provide a synthesis solution, the plurality of solid reagents comprising at least one metal salt and at least one organic linker, the plurality of solid reagents comprising at least one of a base or a buffer;
heating the synthesis solution to form an intermediate product mixture comprising the metal organic framework;
separating the metal organic framework from the intermediate product mixture; and
drying the separated metal organic framework.

20. The method of claim 18, wherein the wash solution is different from the one or more protic solvents in the appending solution.

21. The method of claim 18, wherein the synthesis solution further comprises dispersed solids, wherein the dispersed solids comprise one or more solid reagents from the plurality of solid reagents.
